(19) United States
(12) Patent Application Publication
(10) Pub. No.: US 2026/0298011 A1
(43) Pub. Date: Oct. 1, 2026

(54) POWER TRUNK MECHANISM

(71) Applicants: Hyundai Motor Company, Seoul (KR); Kia Corporation, Seoul (KR); PHA CO., LTD., Daegu (KR)

(72) Inventors: Yong Hyuck IM, Hwaseong-Si (KR); Doo Jung KIM, Daegu (KR)

(73) Assignees: Hyundai Motor Company, Seoul (KR); Kia Corporation, Seoul (KR); PHA CO., LTD., Daegu (KR)

(21) Appl. No.: 19/387,174

(22) Filed: Nov. 12, 2025

(30) Foreign Application Priority Data
Mar. 26, 2025 (KR) 10-2025-0038924

(51) Int. Cl. E05F 15/63; E05D 5/06

(52) U.S. Cl. CPC E05F 15/63; E05D 5/062; E05D 2005/067; E05Y 2201/47; E05Y 2201/478; E05Y 2900/548

(57) ABSTRACT

A power trunk mechanism includes a hinge arm, wherein a first end portion of the hinge arm is coupled to a trunk lid and a second end portion of the hinge arm is coupled to a vehicle body panel forming a trunk compartment, to open or close the trunk lid, a lever unit connected to the vehicle body panel and the hinge arm to implement four-bar linkage motion, and an electric drive unit configured to provide rotation force to the hinge arm and coupled to the hinge arm and the lever unit to be rotatable relative to the hinge arm and the lever unit.

### CROSS-REFERENCE TO THE RELATED APPLICATION

The present application claims priority from Korean Patent Application No. 10-2025-0038924, filed on Mar. 26, 2025, in the Korean Intellectual Property Office, the disclosure of which is incorporated herein by reference in its entirety.

### BACKGROUND OF THE DISCLOSURE

### Field of the disclosure

The present disclosure relates to a power trunk mechanism configured to automatically open or close a trunk lid through development of an electric power trunk mechanism configured for being applied to all types of vehicles regardless of a method of opening and closing the trunk lid.

### Description of the Related Art

A latch is provided on a trunk lid, and a striker is provided on a vehicle body side thereof. In the present structural configuration, when the trunk lid is closed, the latch is engaged with the striker and is locked thereinto. Accordingly, when a release lever is operated, the latch is disengaged from the striker and is unlocked therefrom.

Meanwhile, among the power trunk mechanisms configured to open a trunk lid, a method of opening a trunk through a spring or a gas lifter is mainly applied to large and semi-large vehicles.

Furthermore, a trunk opening/closing device based on a torsion bar is mainly applied to medium and semi-medium vehicles. In the instant case, the torsion bar is connected to each of a vehicle body and a hinge arm, and a trunk lid is opened through elastic force of the torsion bar.

However, it is difficult to apply a spring-based power trunk mechanism to a torsion bar-based trunk opening/closing device.

The information disclosed in this Background of the Disclosure section is only for enhancement of understanding of the general background of the disclosure, and should not be taken as an acknowledgement or any form of suggestion that this information forms the prior art already known to a person skilled in the art.

### SUMMARY

Therefore, the present disclosure has been made in view of the above problems, and it is an aspect of the present disclosure to provide a power trunk mechanism configured to automatically open or close a trunk lid through development of an electric power trunk mechanism configured for being applied to all types of vehicles regardless of a method of opening and closing the trunk lid.

The aspects of the present disclosure are not limited to the above-mentioned aspects, and other technical aspects not mentioned herein will be clearly understood by those skilled in the art to which the present disclosure pertains from the detailed description of the embodiments.

In accordance with the present disclosure, the above and other aspects may be accomplished by the provision of a power trunk mechanism including a hinge arm, wherein a first end portion of the hinge arm is coupled to a trunk lid and a second end portion of the hinge arm is coupled to a vehicle body panel forming a trunk compartment, to open or close the trunk lid, a lever unit connected to the vehicle body panel and the hinge arm to implement four-bar linkage motion, the lever unit being restricted by the vehicle body panel and the hinge arm, and an electric drive unit coupled to the hinge arm and the lever unit to be rotatable relative to the hinge arm and the lever unit, and configured to provide rotation force to the hinge arm.

The lever unit may include a hinge link rotatably connected to the hinge arm, the hinge link being formed to extend toward a front space of the trunk, and a vehicle body member rotatably connected between the hinge link and a front vehicle body panel.

The vehicle body member may be a torsion bar configured to provide an elastic force in a direction in which the trunk lid is opened.

The vehicle body panel may include a seating groove disposed therein and formed to have an upwardly open shape, the seating groove being configured for an upper end portion of the vehicle body member to be accommodated in the seating groove, and the hinge link may include a hooking groove disposed therein and formed to include a downwardly open shape, the hooking groove being configured for a lower end portion of the vehicle body member to be hooked in the hook groove.

A fixing lever may be coupled to the vehicle body panel adjacent to the seating groove, and the fixing lever may include a shape configured to block, through rotation of the fixing lever, the vehicle body member accommodated in the seating groove.

A ring-shaped hook may be coupled to the hinge link adjacent to the hooking groove, and the hook may include a shape configured to surround, through rotation of the hook, the vehicle body member hooked in the hooking groove.

The power trunk mechanism may further include a return spring configured to provide elastic restoring force to the hook in a rotation direction of the hook, the rotation direction allowing the hook to surround the vehicle body member.

The vehicle body member may be formed to include a wire shape bent in a "U" shape and may be connected to each of the hinge link and the vehicle body panel through a hooking structure, and the vehicle body member may include a stopper provided at an end portion thereof, the stopper being formed to include an extending shape to prevent separation of the vehicle body member from the vehicle body panel.

The vehicle body member may be a vehicle body link having high rigidity, the vehicle body link being pin-coupled to the hinge link and the vehicle body panel to withstand a load of the trunk lid.

The power trunk mechanism may further include a spring coupled to the hinge arm and configured to provide rotation force in a rotation direction of the hinge arm, the rotation direction allowing the trunk lid to be opened.

The spring may have one end portion connected to a vehicle body and the other end portion connected to one of the hinge arm and the lever unit.

The power trunk mechanism may further include a gas lifter coupled to the hinge arm and configured to provide rotation force in a rotation direction of the hinge arm, the rotation direction allowing the trunk lid to be opened.

The gas lifter may have one end portion connected to a vehicle body and the other end portion connected to one of the hinge arm and the lever unit.

The electric drive unit may be rotated relative to the hinge arm in a direction opposite to a rotation direction of the hinge arm.

The lever unit may be connected to a front side of the hinge arm, and the electric drive unit may be connected between the hinge arm and the lever unit so that the electric drive unit is constantly located in front of the hinge arm.

The electric drive unit may include a motor bracket fixed to the hinge arm, a motor assembly including a motor configured to provide rotation force to the hinge arm and a rotation shaft rotated in conjunction with the motor and coupled to the motor bracket, and a connecting link rotatably connected between the motor assembly and the vehicle body member.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a view showing a state in which a power trunk mechanism according to a disclosed embodiment is mounted on a trunk lid;

FIG. 2 is a view showing the power trunk mechanism according to the exemplary embodiment of the present disclosure;

FIGS. 3, 4 and 5 are views each showing the opening/closing operation of the trunk lid using the power trunk mechanism according to the exemplary embodiment of the present disclosure;

FIGS. 6 and 7 are views for description of an assembly structure of a torsion bar as a vehicle body member according to the exemplary embodiment of the present disclosure;

FIG. 8 is a cross-sectional view taken along line A-A in FIG. 7, showing an assembly structure of a fixing lever;

FIG. 9 is a view showing a structure in which a stopper is mounted on the torsion bar according to the exemplary embodiment of the present disclosure;

FIGS. 10 and 11 are views each showing a configuration in which a spring is used in a structure in which a vehicle body link is employed as the vehicle body member according to the exemplary embodiment of the present disclosure; and

FIG. 12 is a view showing a configuration in which a gas lifter is used in the structure in which the vehicle body link is employed as the vehicle body member according to the exemplary embodiment of the present disclosure.

### DETAILED DESCRIPTION OF THE EXEMPLARY EMBODIMENTS

In describing the embodiments disclosed herein, when it is determined that a detailed description of publicly known techniques to which the disclosure pertains may obscure the gist of the present disclosure, the detailed description will be omitted. Furthermore, it should be understood that the accompanying drawings are merely illustrated to easily describe the embodiments disclosed in this specification, and therefore, the technical idea disclosed in this specification is not limited by the accompanying drawings. Furthermore, it should be noted that the accompanying drawings include all modifications, equivalents, and substitutes that fall within the spirit and technical scope of the present disclosure. The disclosure below is not intended to limit the present disclosure to a form described in the present disclosure or to a specific field, and it is contemplated that various alternative aspects and modifications to the present disclosure are possible, whether explicitly described or implied herein. It will be appreciated by those skilled in the art to which the present disclosure pertains that the form and details of the present disclosure may vary.

The present disclosure will be described with reference to specific aspects. However, as will be appreciated by those skilled in the art to which the present disclosure pertains, various aspects disclosed herein may be modified or otherwise implemented in various other ways without departing from the spirit and scope of the disclosure. Accordingly, the following description is to be considered as illustrative and is for teaching those skilled in the art the manner of making and using various embodiments. It is to be understood that the forms of disclosure herein shown and described are to be taken as representative embodiments. Equivalent elements, materials, processes, or steps may be substituted for those representatively illustrated and described herein. Expressions such as "including", "comprising", "incorporating", "consisting of", "have", and "is" used to describe and claim the present disclosure are intended to be construed in a non-exclusive manner, that is, to allow for items, components or elements not explicitly described herein to be present. Reference to the singular is also to be construed to relate to the plural.

Furthermore, various embodiments disclosed herein are to be taken in the illustrative and explanatory sense and should not be construed as limiting the scope of the present disclosure. All references to joining (for example, attached, affixed, coupled, connected, and the like) are only used to aid the reader's understanding of the present disclosure and are not intended to limit the position, orientation, or use of a configuration and/or methods disclosed herein. Therefore, references to joining, if any, are to be construed broadly. Moreover, such references to joining do not necessarily imply that two or more elements are directly connected to each other. Additionally, all numerical terms, such as, but not limited to, "first", "second", "third", "primary", "secondary", "main" or any other ordinary and/or numerical terms, should also be taken only as identifiers, to assist the reader's understanding of the various elements, embodiments, variations and/or modifications of the present disclosure, and may not create any limitations, particularly as to any component, embodiment, variation, and/or modification, or the order or preference thereof. That is, while these expressions may be used to describe various components, the components are not limited by the corresponding expressions. These expressions are used only for distinguishing one component from another.

Hereinafter, the suffixes "module", "unit", and "part" for components used in the following description are merely provided for facilitation of preparing the present specification. Therefore, the suffixes themselves do not have significant meanings or roles.

When one component is referred to as being "connected" or "joined" to another component, the one component may be directly connected or joined to the other component, but it should be understood that other components may be present therebetween. On the other hand, when the one component is referred to as being "directly connected to" or "directly in contact with" the other component, it should be understood that no other components are present therebetween.

Furthermore, "unit" or "control unit" is only a term widely used in naming a controller configured for controlling a predetermined function of the vehicle, and does not mean a generic functional unit.

Examples of the device may include a communication device configured to communicate with other controllers or sensors to control the corresponding function, a non-transitory computer-readable medium configured to store an operating system or logic commands and input/output information, and one or more processors configured to perform determination, calculation, communication, and the like necessary for controlling the corresponding function.

Any number or components or a variety of components in any of the configurations described herein may be included within the disclosure described herein. The components may include any combination of the features described herein and may be arranged in any of the various configurations described herein. The structure and arrangement of the components of the present disclosure, as well as the concepts regarding the use and operation thereof may be applied not only to the specific embodiments discussed herein, but also to any number of embodiments in any combination. Embodiments including those including various features in various arrangements will be described below with reference to the drawings.

Hereinafter, various embodiments disclosed herein will be described in detail with reference to accompanying drawings, and regardless of the drawing symbols, the same or similar components will be denoted by the same reference numerals, and redundant descriptions thereof will be omitted.

According to a disclosed embodiment, a power trunk mechanism includes a hinge arm 100 coupled to a trunk lid 10 and rotatably coupled to a vehicle body panel 400 forming a trunk compartment to open or close the trunk lid 10, a lever unit connected to the vehicle body panel 400 and the hinge arm 100 to implement four-bar linkage motion, the lever unit being restricted by the vehicle body panel 400 and the hinge arm 100, and an electric drive unit 500 configured to provide rotation force to the hinge arm 100 and coupled to the hinge arm 100 and the lever unit to be rotatable relative to the hinge arm 100 and the lever unit.

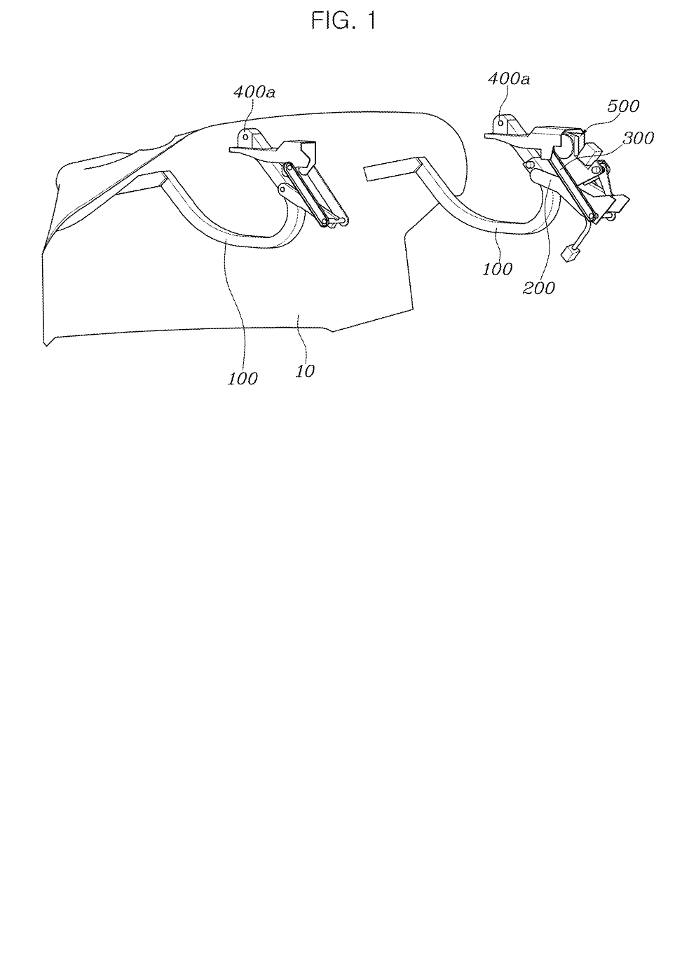

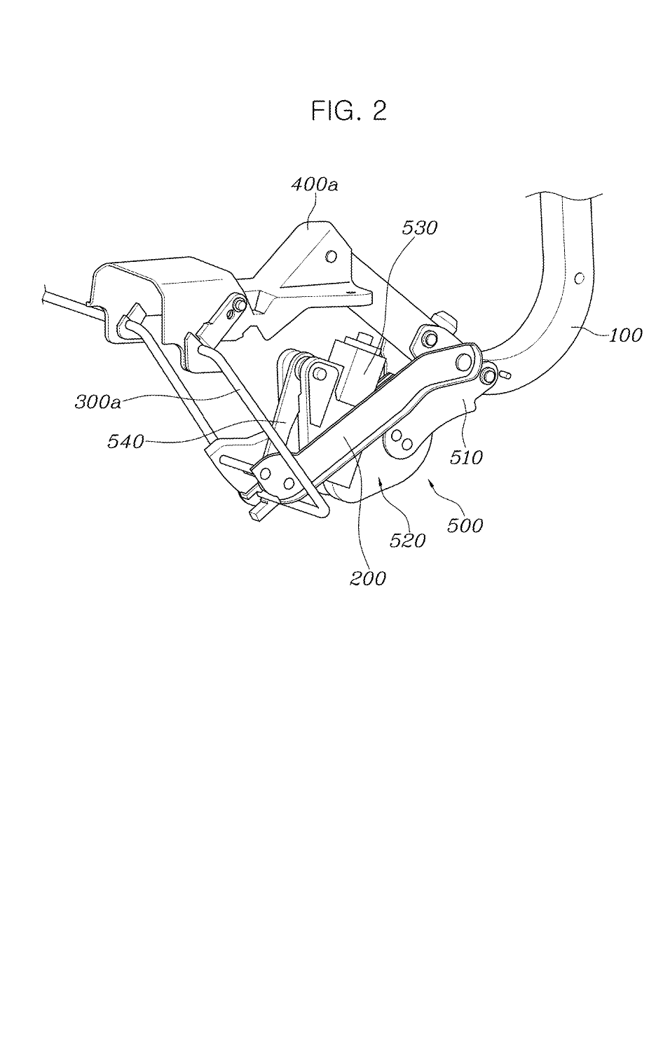

Referring to FIGS. 1 and 2, vehicle body brackets 400a are respectively coupled to, in the forward-and-rearward direction of the vehicle body panel 400, both sides of the ceiling surface of the vehicle body panel 400 forming the internal space of a trunk.

The front end portion of the hinge arm 100 is rotatably hinged to the rear end portion of the vehicle body bracket 400a, and the rear end portion of the hinge arm 100 is coupled to the ceiling surface of the trunk lid 10.

Furthermore, a middle portion of the hinge arm 100 is formed to be bent downwards, and the lever unit including a vehicle body member 300 and a hinge link 200 is connected to the vehicle body bracket 400a and the hinge arm 100 to form a four-bar linkage structure between a middle portion of the hinge arm 100 and a front end portion of the vehicle body bracket 400a.

Accordingly, when the trunk lid 10 is opened and closed, the vehicle body bracket 400a is configured as a fixed link in the four-bar linkage structure. In the instant case, the hinge arm 100 and the lever unit implement four-bar linkage motion with the vehicle body bracket 400a configured as a fixed link, and the trunk lid 10 coupled to the hinge arm 100 is opened and closed.

The electric drive unit 500 is disposed between the hinge arm 100 and the lever unit, and rotational driving force of a motor 530 provided from the electric drive unit 500 is transmitted to the hinge arm 100 to rotate the hinge arm 100.

In the present manner, the exemplary embodiment of the present disclosure implements a power trunk mechanism including an electric opening/closing structure through the electric drive unit 500 applied between the hinge arm 100 and the lever unit, automatically opening and closing the trunk lid 10.

Furthermore, the lever unit includes the hinge link 200 rotatably connected to the hinge arm 100 and formed to extend toward a front space of the trunk, and the vehicle body member 300 rotatably connected between the hinge link 200 and the front vehicle body panel 400.

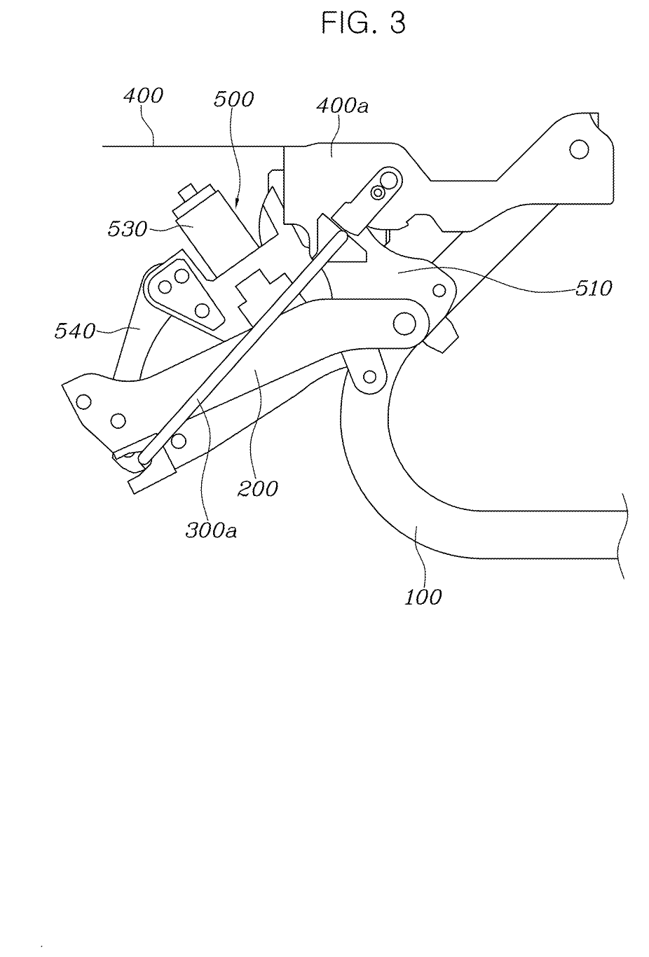

Referring to FIGS. 2 and 3, the upper end portion of the vehicle body member 300 is rotatably accommodated in the front end portion of the vehicle body bracket 400a.

Furthermore, since the hinge link 200 is disposed in the forward-and-rearward direction, the rear end portion of the hinge link 200 is hinged to a middle portion of the hinge arm 100 to perform relative rotation, and the lower end portion of the vehicle body member 300 is rotatably hooked in the front end portion of the hinge link 200.

Accordingly, when the trunk lid 10 is opened and closed, the hinge arm 100, the hinge link 200, and the vehicle body member 300 implement four-bar linkage motion with the vehicle body bracket 400a configured as a fixed link, enabling the trunk lid 10 coupled to the hinge arm 100 to be opened and closed.

In the exemplary embodiment of the present disclosure, as an example of the vehicle body member 300, the vehicle body member 300 may be a torsion bar 300a configured to provide an elastic force in a direction in which the trunk lid 10 is opened.

That is, as shown in FIGS. 3, 4 and 5, when the hinge arm 100 is rotated in the direction in which the trunk lid 10 is opened, the lower end portion of the torsion bar 300a pushes the lower end portion of the hinge link 200 toward the rear side of the vehicle through elastic force of the torsion bar 300a.

Therefore, since rotational operation force of the electric drive unit 500 configured to rotate the hinge arm 100 is supported by elastic force of the torsion bar 300a, the size of the motor 530 of the electric drive unit 500 is minimized, reducing the cost and weight of the electric drive unit 500.

Meanwhile, according to the exemplary embodiment of the present disclosure, the vehicle body panel 400 includes a seating groove 410 disposed therein and formed to have an upwardly open shape, and the upper end portion of the vehicle body member 300 is accommodated in the seating groove 410. Furthermore, the hinge link 200 includes a hooking groove 210 disposed therein and formed to include a downwardly open shape, and the lower end portion of the vehicle body member 300 is hooked in the hooking groove 210.

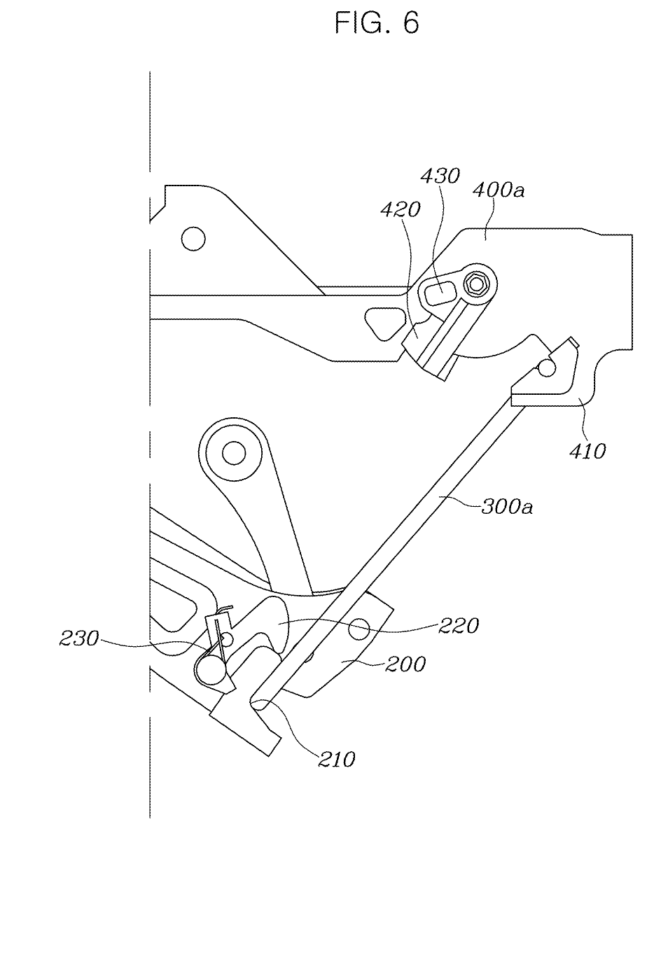

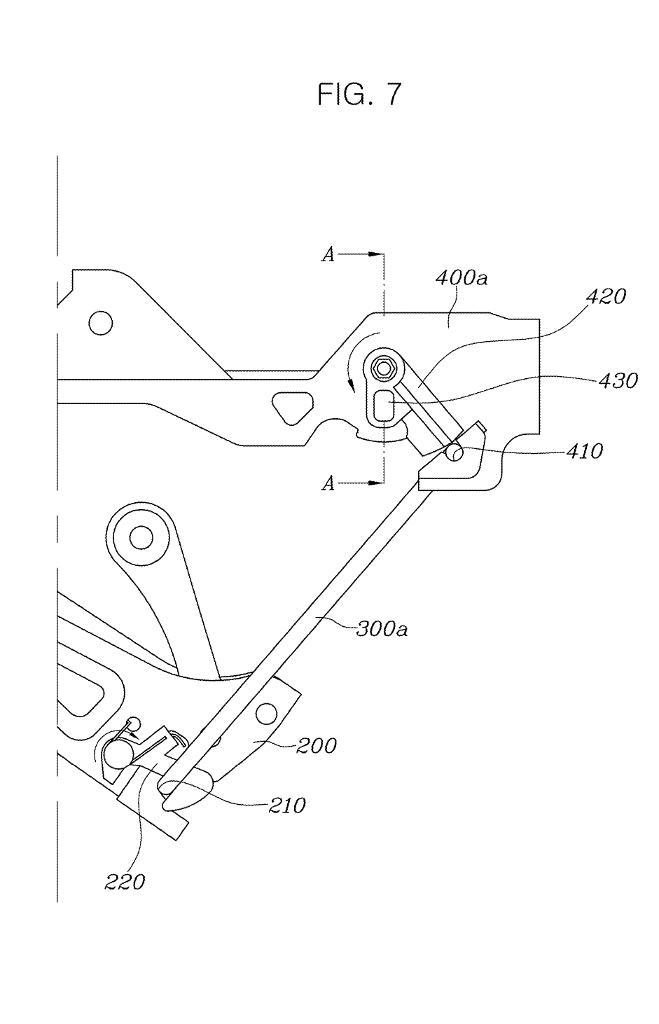

Referring to FIGS. 6 and 7, the seating groove 410 is formed in a lower portion of the vehicle body bracket 400a coupled to the vehicle body panel 400, and the seating groove 410 is formed to include an open shape with a "U"-shaped cross section toward the upper rear side of the vehicle.

Furthermore, the hooking groove 210 is formed in a lower portion of the rear end portion of the hinge link 200, and the hooking groove 210 is formed to include an open shape with a "U"-shaped cross section toward the lower front side of the vehicle.

That is, the opening directions of the seating groove 410 and the hooking groove 210 are oriented in opposite directions. Here, the upper end portion of the torsion bar 300a is rotatably accommodated in the seating groove 410, and the lower end portion of the torsion bar 300a is rotatably hooked in the hooking groove 210, preventing the torsion bar 300a from being separated from the vehicle body panel 400 and the hinge link 200 during rotation of the hinge arm 100. In the present manner, four-bar linkage rotation motion may be stably implemented.

Furthermore, a fixing lever 420 may be coupled to the vehicle body panel 400 adjacent to the seating groove 410, and the fixing lever 420 may include a shape configured for blocking, through rotation of the fixing lever 420, the vehicle body member 300 accommodated in the seating groove 410.

Referring to FIGS. 6 and 7, one end portion of the fixing lever 420 is pin-coupled to the vehicle body bracket 400a located at the rear upper side of the seating groove 410, allowing the other end portion of the fixing lever 420 to be rotated around one end portion of the fixing lever 420.

Therefore, since the other end portion of the fixing lever 420 is located above the seating groove 410 during rotation of the fixing lever 420, the torsion bar 300a accommodated in the seating groove 410 is blocked by the fixing lever 420, preventing movement of the upper end portion of the torsion bar 300a in the seating groove 410 or separation of the upper end portion of the torsion bar 300a from the seating groove 410. In the present manner, movement of the torsion bar 300a is restricted in the seating groove 410.

For reference, the fixing levers 420 may be respectively disposed on opposite sides of the vehicle body bracket 400a. In the instant case, the fixing levers 420 respectively disposed on the opposite sides of the vehicle body bracket 400a may be connected to each other through a shaft so that one fixing lever 420 is simultaneously rotatable in conjunction with rotation of the other fixing lever 420.

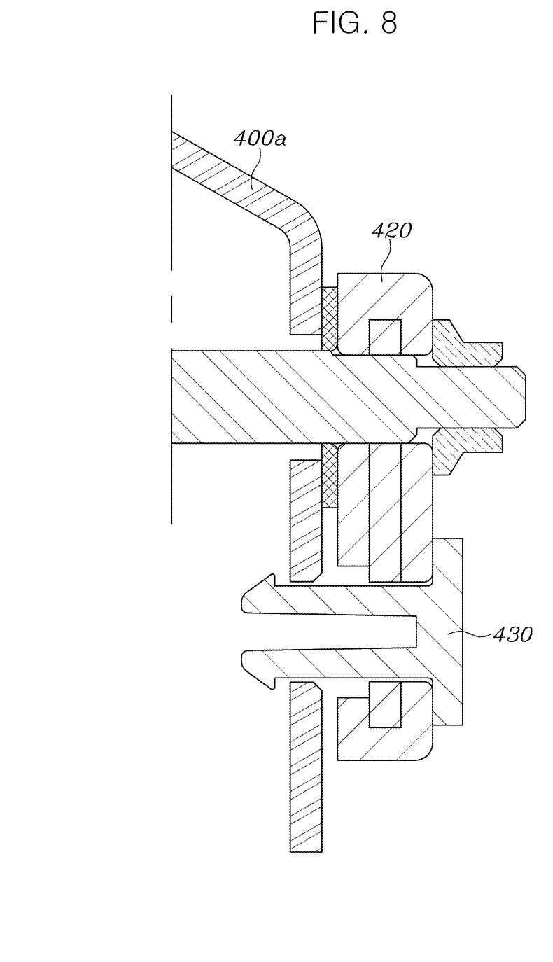

Furthermore, as shown in FIG. 8, since the fixing lever 420 is pin-coupled to the vehicle body bracket 400a by a fixing pin 430, the position of the fixing lever 420 may be regulated in a state in which the fixing lever 420 is rotated.

Furthermore, a hook 220 including an annular shape is coupled to the hinge link 200 adjacent to the hooking groove 210, and the hook 220 may include a shape configured for surrounding, through rotation of the hook 220, the vehicle body member 300 hooked in the hooking groove 210.

Referring to FIGS. 6 and 7, one end portion of the hook 220 is pin-coupled to the hinge link 200 located at the upper rear side of the hooking groove 210, and the other end portion of the hook 220 may be rotated around the one end portion of the hook 220.

The other end portion of the hook 220 may be formed to include an annular shape.

Therefore, the other end portion of the hook 220 blocks the hooking groove 210 in conjunction with rotation of the hook 220 and is hooked on the torsion bar 300a hooked in the hooking groove 210, preventing the lower end portion of the torsion bar 300a from being separated from the hooking groove 210.

Furthermore, the hook 220 includes a return spring 230 mounted in one end portion thereof and configured to provide elastic restoring force in a rotation direction in which the hook 220 is hooked on the torsion bar 300a, more reliably maintaining the hooked state of the hook 220 hooked on the torsion bar 300a. In the present manner, the torsion bar 300a is prevented from being separated from the hooking groove 210, and movement of the torsion bar 300a is restricted in the hooking groove 210.

For reference, the return spring 230 is a torsion spring inserted into one end portion of the hook 220. One end portion of the return spring 230 may be supported by the hook 220, and the other end portion thereof may be supported by the hinge link 200.

That is, an assembly process of the torsion bar 300a according to the above-described configuration will be referred to as an example. The upper end portion of the torsion bar 300a is inserted into the seating groove 410 and is accommodated therein, and then the lower end portion of the torsion bar 300a is inserted into the hooking groove 210.

Accordingly, movement of the lower end portion of the torsion bar 300a inserted into the hooking groove 210 is restricted by rotation of the hook 220, and movement of the upper end portion of the torsion bar 300a inserted into the seating groove 410 is restricted by rotation of the fixing lever 420. In the present manner, the torsion bar 300a is assembled with the vehicle body bracket 400a and the hinge link 200 and is located therebetween.

Meanwhile, in the exemplary embodiment of the present disclosure, the vehicle body member 300 is formed to include a wire shape which is bent in a "U" shape and is connected to the hinge link 200 and the vehicle body panel 400 through a hooking structure, respectively, and the vehicle body member 300 includes a stopper 310 provided at the end portion thereof and formed to include an extending shape to prevent the vehicle body member 300 from being separated from the vehicle body panel 400.

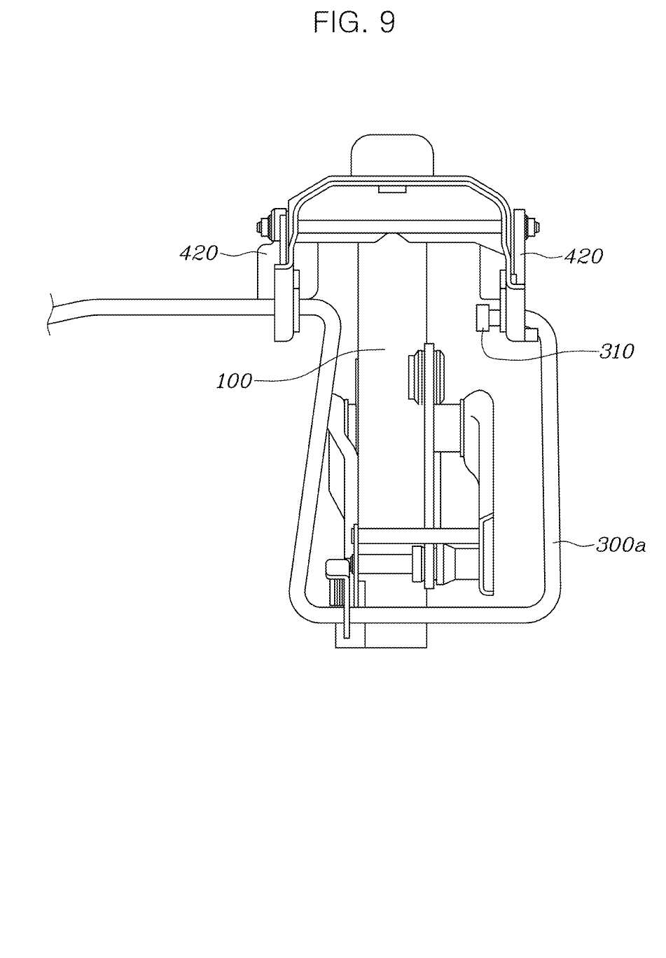

Referring to FIG. 9, the torsion bar 300a is formed to include a wire shape, and one upper end side of the torsion bar 300a passes through one side of the vehicle body bracket 400a to be coupled thereto, and the other upper end side of the torsion bar 300a passes through the other side of the vehicle body bracket 400a to be coupled thereto.

The stopper 310 including an external diameter formed to be greater than the internal diameter of the seating groove 410 is fixed to the end portion of the torsion bar 300a, which protrudes toward the internal side of the vehicle body bracket 400a.

Therefore, when the torsion bar 300a is opened outwards from the vehicle body bracket 400a, the stopper 310 is supported by the internal surface of the vehicle body bracket 400a. In the instant case, since the torsion bar 300a is prevented from being opened outwards, separation of the torsion bar 300a is prevented.

Meanwhile, as another embodiment of the vehicle body member 300 of the exemplary embodiment of the present disclosure, the vehicle body member 300 may be a vehicle body link 300b having high rigidity, which is pin-coupled to the hinge link 200 and the vehicle body panel 400 to withstand the load of the trunk lid 10.

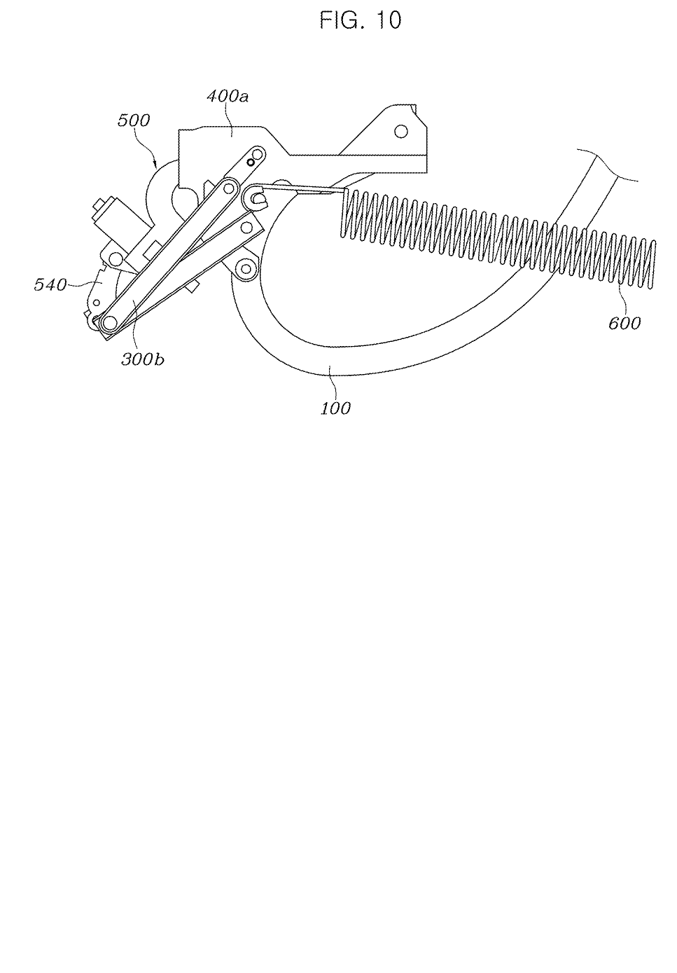

Referring to FIG. 10, the upper end portion of the vehicle body link 300b is pin-coupled to the front end portion of a hinge bracket with a hinge structure, and the lower end portion of the vehicle body link 300b is pin-coupled to the front end portion of the hinge link 200 with a hinge structure.

That is, the vehicle body link 300b including a link shape is provided as another embodiment of the vehicle body member 300 and connects the vehicle body bracket 400a to the hinge link 200 in a state of being located therebetween. In the present manner, the vehicle body link 300b is connected to the vehicle body bracket 400a and the hinge link 200 in a completely restricted state, making it possible not only to prevent separation of the vehicle body link 300b, but also to more stably withstand the load of the trunk lid 10.

Furthermore, the exemplary embodiment of the present disclosure may further include a spring 600 configured to provide rotation force in the rotation direction of the hinge arm 100 in which the trunk lid 10 is opened.

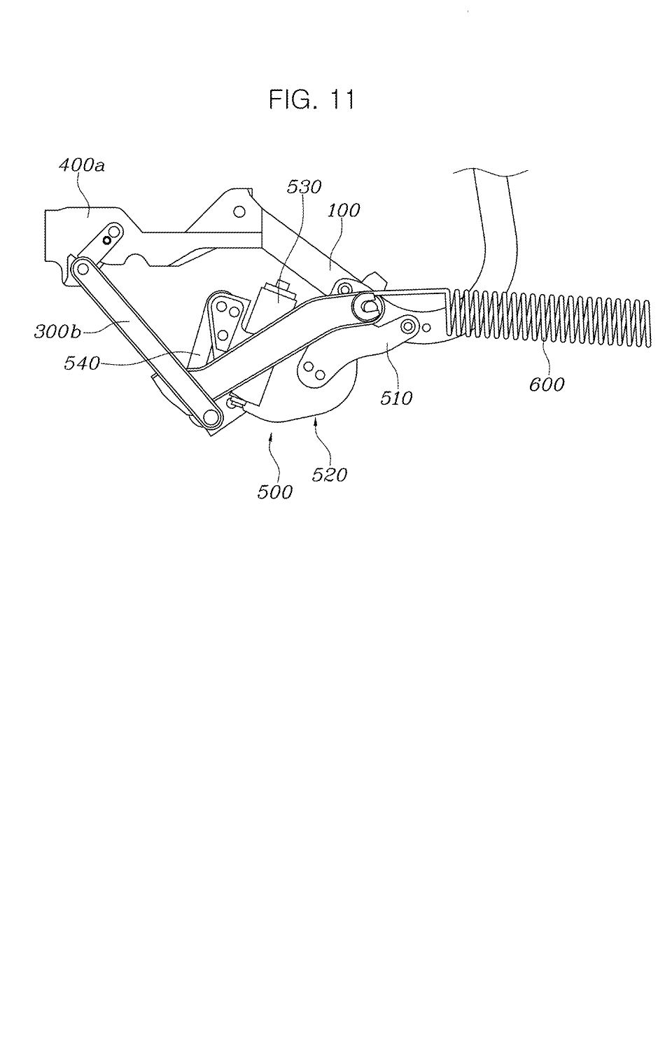

Referring to FIGS. 10 and 11, when the vehicle body link 300b is employed as the vehicle body member 300, the separate spring 600 may be provided to withstand the weight of the trunk lid 10.

The spring 600 includes a coil spring structure. Here, the front end portion of the spring 600 may be connected to any one of the vehicle body link 300b, the hinge link 200, and the hinge arm 100, and the rear end portion of the spring 600 may be connected to the vehicle body.

Therefore, since rotational operation force of the electric drive unit 500 configured to rotate the hinge arm 100 is supported by elastic force of the spring 600, the motor 530 of the electric drive unit 500 is miniaturized, reducing the cost and weight of the electric drive unit 500.

Furthermore, the exemplary embodiment of the present disclosure may further include a gas lifter 700 configured to provide rotation force in a rotation direction of the hinge arm 100 in which the trunk lid 10 is opened.

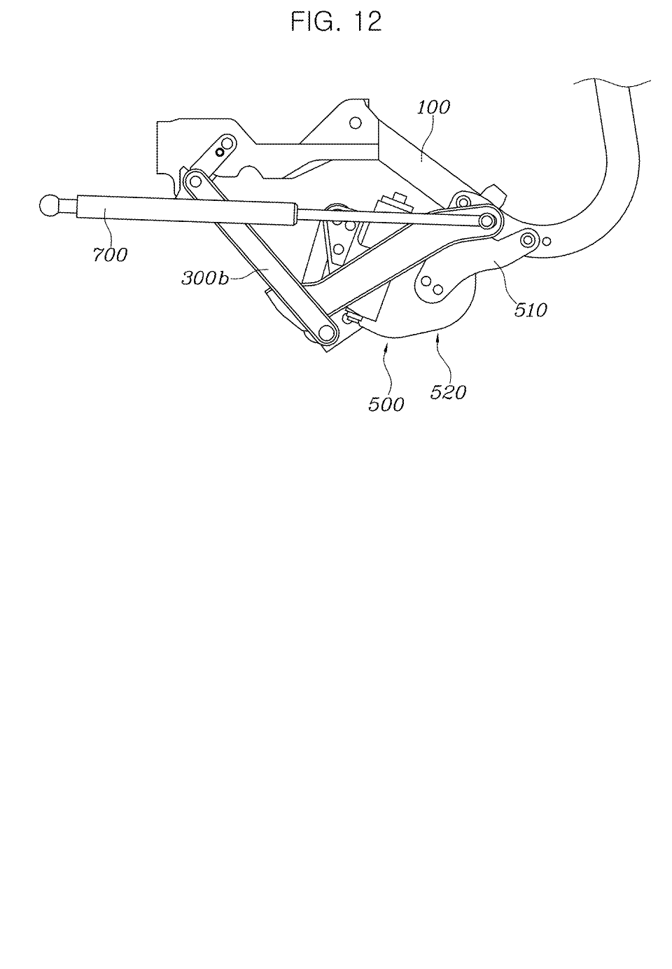

Referring to FIG. 12, when the vehicle body link 300b is employed as the vehicle body member 300, the separate gas lifter 700 may be provided to withstand the weight of the trunk lid 10.

The rear end portion of the gas lifter 700 may be connected to any one of the vehicle body link 300b, the hinge link 200, and the hinge arm 100, and the front end portion of the gas lifter 700 may be connected to the vehicle body.

In the instant case, since rotational operation force of the electric drive unit 500 configured to rotate the hinge arm 100 is supported by force through which the gas lifter 700 is lifted, the motor 530 of the electric drive unit 500 is miniaturized, reducing the cost and weight of the electric drive unit 500.

Meanwhile, in the exemplary embodiment of the present disclosure, the electric drive unit 500 may be rotated relative to the hinge arm 100 in a direction opposite to the rotation direction of the hinge arm 100.

That is, the electric drive unit 500 may be rotated relative to the hinge arm 100 in the direction opposite to the rotation direction of the hinge arm 100 according to rotation of the hinge arm 100.

Referring to FIGS. 3, 4 and 5, in a case where rotation force is applied to the hinge arm 100 by operating the motor 530 in a direction in which the trunk lid 10 is opened, when the hinge arm 100 is rotated counterclockwise with respect to the vehicle body bracket 400a, the electric drive unit 500 is rotated in the rotation direction of the hinge arm 100 and is rotated clockwise between the hinge arm 100 and the lever unit.

Conversely, in a case where the motor 530 is operated in a direction in which the trunk lid 10 is closed, when the hinge arm 100 is rotated clockwise with respect to the vehicle body bracket 400a, the electric drive unit 500 is rotated in the rotation direction of the hinge arm 100 and is rotated counterclockwise between the hinge arm 100 and the lever unit.

That is, when the hinge arm 100 is rotated in the direction in which the trunk lid 10 is opened, downward movement of a rotation boundary of the electric drive unit 500 is smaller than that of a rotation boundary of the hinge arm 100. Accordingly, the electric drive unit 500 is maximally suppressed from being exposed to the outside of the trunk.

However, the electric drive unit 500 may be provided to be rotatable in conjunction with rotation of the hinge arm 100 in a restricted state without being rotated relative to the hinge arm 100 during the rotation process of the hinge arm 100.

Furthermore, the exemplary embodiment of the present disclosure may be configured so that the lever unit is connected to the front side of the hinge arm 100, and the electric drive unit 500 is connected between the hinge arm 100 and the lever unit so that the electric drive unit 500 is constantly located in front of the hinge arm 100.

That is, as shown in FIGS. 3, 4 and 5, since the electric drive unit 500 is connected between the hinge arm 100 and the vehicle body member 300, the electric drive unit 500 is constantly located inside the trunk regardless of the opening-and-closing operation of the trunk lid 10, maximally reducing the exposure of the electric drive unit 500.

Therefore, the minimum size of luggage trim may be used to cover the electric drive unit 500 and accordingly, the internal space of the trunk may be maximally utilized.

Furthermore, the electric drive unit 500 includes a motor bracket 510 fixed to the hinge arm 100, a motor assembly 520 including the motor 530 configured to provide rotation force to the hinge arm 100 and a rotation shaft 531 rotated in conjunction with the motor 530 and coupled to the motor bracket 510, and a connecting link 540 rotatably connected between the motor assembly 520 and the vehicle body member 300.

Referring to FIGS. 2, 3, 4 and 5, the motor bracket 510 is formed to include a triangular plate shape, and one bottom surface of the motor bracket 510 is coupled to a curved middle portion of the hinge arm 100 through bolting or the like.

Furthermore, the motor 530 is mounted on the front upper end portion of the motor assembly 520. The motor assembly 520 may include a worm gear built therein and configured to be rotated by receiving rotation force from the motor 530. Additionally, the motor assembly 520 may include a worm wheel disposed therein and formed to include an external gear to be engaged with the worm gear and at least one output gear disposed therein and configured to be externally engaged with the worm wheel.

In the instant case, a shaft of a final output gear is provided to be exposed to the outside of the side surface of the motor assembly 520, and the shaft of the final output gear is configured as the rotation shaft 531.

Accordingly, an apex portion facing one bottom surface of the motor bracket 510 is fixedly coupled to the rotation shaft 531, and rotation force of the motor 530 is transmitted to the hinge arm 100 through the motor bracket 510.

Furthermore, the upper end portion of the connecting link 540 is rotatably hinged to the front end portion of the motor assembly 520, and the lower end portion of the connecting link 540 is rotatably hinged to the front end portion of the hinge link 200.

Therefore, during the rotational operation of the motor 530, when the rotation shaft 531 is rotated through a gear engagement structure inside the motor assembly 520, the motor bracket 510 is rotated in the same direction as the rotation shaft 531 because the rotation shaft 531 is fixed to the motor bracket 510, rotating the hinge arm 100 coupled to the motor bracket 510.

For reference, the motor brackets 510 are respectively coupled to opposite sides of the hinge arm 100, and the motor assembly 520 is disposed with the motor brackets 510 and is interposed therebetween. Furthermore, the hinge links 200 are respectively coupled to opposite sides of the hinge arm 100, and each of the hinge links 200 is formed to include a shape configured for covering a corresponding one of the opposite side surfaces of the motor brackets 510. Through such a structural configuration, the electric drive unit 500 is provided between the opposite hinge links 200.

Hereinafter, the operation process of the power trunk mechanism according to the exemplary embodiment of the present disclosure will be described with reference to FIGS. 3, 4 and 5. When the motor 530 is operated in a direction in which the trunk lid 10 is opened, the rotation shaft 531 is rotated by rotation force of the motor 530.

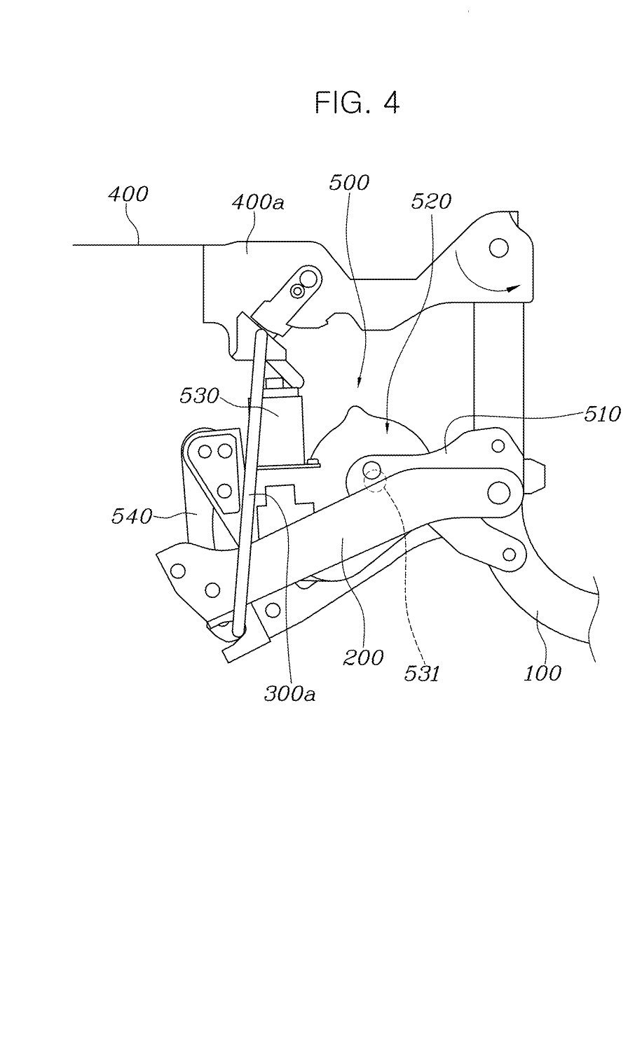

Accordingly, when the motor bracket 510 is rotated counterclockwise in conjunction with rotation of the rotation shaft 531, the hinge arm 100 coupled to the motor bracket 510 is rotated counterclockwise around the vehicle body bracket 400a, as shown in FIG. 4.

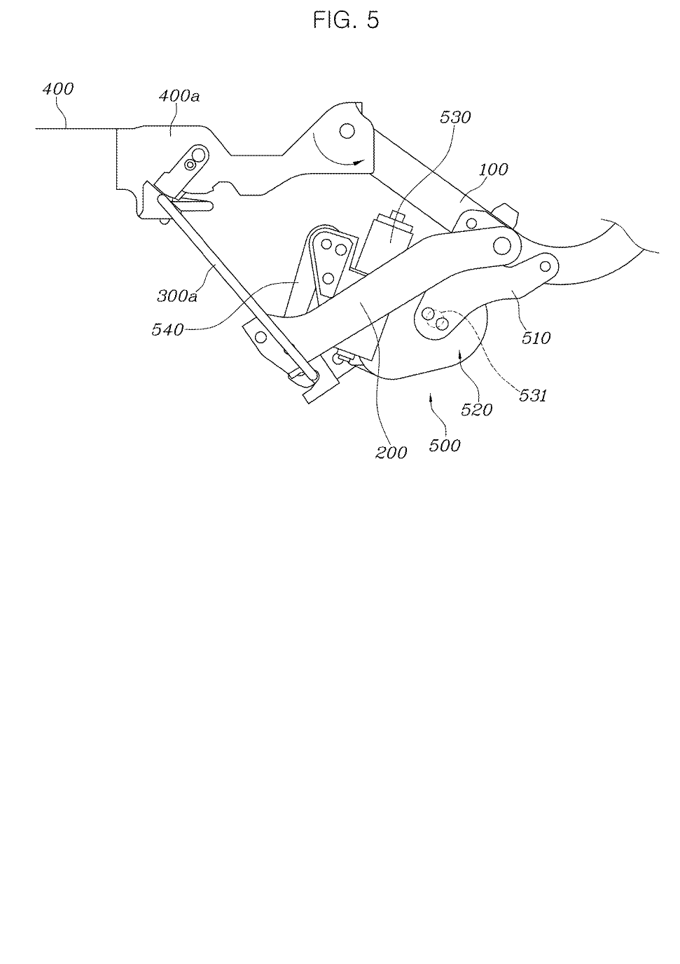

Accordingly, when rotation force of the motor 530 is continuously applied, the counterclockwise rotation angle of the hinge arm 100 is increased, as shown in FIG. 5, completely opening the trunk lid 10 coupled to the hinge arm 100.

However, when the hinge arm 100 is rotated counterclockwise around the vehicle body bracket 400a, the motor assembly 520 is rotated in the rotation direction of the hinge arm 100 but is rotated clockwise. Accordingly, downward movement of a rotation boundary of the motor assembly 520 is smaller than that of a rotation boundary of the hinge arm 100, and thus the motor assembly 520 is not exposed to the outside thereof.

As described above, the exemplary embodiment of the present disclosure implements a power trunk mechanism including an electric opening/closing structure through the electric drive unit 500 applied between the torsion bar 300 and the hinge arm 100, automatically opening and closing the trunk lid 10 regardless of a structure of the power trunk mechanism.

Furthermore, since the electric drive unit 500 is located inside the trunk to maximally reduce external exposure of the electric drive unit 500, the minimum size of luggage trim may be used to cover the electric drive unit 500, and the internal space of the trunk may be maximally utilized.

As is apparent from the above description, the present disclosure implements a power trunk mechanism including an electric opening/closing structure through an electric drive unit applied between a hinge arm and a vehicle body member, having an effect of automatically opening and closing a trunk lid regardless of a power trunk structure.

Furthermore, since the electric drive unit is located inside a trunk to maximally reduce the external exposure of the electric drive unit, the minimum size of luggage trim is used to cover the electric drive unit, having an effect of maximally utilizing the internal space of the trunk.

The effects of the present disclosure are not limited to the above-mentioned effects, and other effects not mentioned herein will be clearly understood by those skilled in the art to which the present disclosure pertains from the detailed description of the embodiments.

Although the specific embodiments of the present disclosure have been disclosed for illustrative purposes, those skilled in the art will appreciate that various modifications, additions, and substitutions are possible, without departing from the scope and spirit of the disclosure as disclosed in the accompanying claims.

What is claimed is:

1. A power trunk mechanism comprising:
a hinge arm, wherein a first end portion of the hinge arm is coupled to a trunk lid and a second end portion of the hinge arm is coupled to a vehicle body panel forming a trunk compartment, to open or close the trunk lid;
a lever unit connected to the vehicle body panel and the hinge arm to implement four-bar linkage motion, the lever unit being restricted by the vehicle body panel and the hinge arm; and
an electric drive unit coupled to the hinge arm and the lever unit to be rotatable relative to the hinge arm and the lever unit, and configured to provide rotation force to the hinge arm.

2. The power trunk mechanism of claim 1, wherein the lever unit comprises:
a hinge link rotatably connected to the hinge arm, the hinge link being formed to extend toward a front space of the trunk; and
a vehicle body member rotatably connected between the hinge link and a front vehicle body panel.

3. The power trunk mechanism of claim 2, wherein the vehicle body member includes a torsion bar configured to provide an elastic force in a direction in which the trunk lid is opened.

4. The power trunk mechanism of claim 2,
wherein the vehicle body panel includes a seating groove disposed therein and formed to have an upwardly open shape, the seating groove being configured for an upper end portion of the vehicle body member to be accommodated in the seating groove, and
wherein the hinge link includes a hooking groove disposed therein and formed to include a downwardly open shape, the hooking groove being configured for a lower end portion of the vehicle body member to be hooked in the hook groove.

5. The power trunk mechanism of claim 4, further including:
a fixing lever coupled to the vehicle body panel adjacent to the seating groove,
wherein the fixing lever includes a shape configured to block, through rotation of the fixing lever, the vehicle body member accommodated in the seating groove.

6. The power trunk mechanism of claim 4,
wherein a hook is coupled to the hinge link adjacent to the hooking groove, and
wherein an end portion of the hook is configured to surround, through rotation of the hook, the vehicle body member hooked in the hooking groove.

7. The power trunk mechanism of claim 6, further comprising a return spring coupled to the hook and configured to provide elastic restoring force to the hook in a rotation direction of the hook, the rotation direction allowing the hook to surround the vehicle body member.

8. The power trunk mechanism of claim 5,
wherein the vehicle body panel further includes a vehicle body bracket,
wherein an end portion of the vehicle body bracket includes the seating groove, and
wherein the fixing lever is pin-coupled to the vehicle body bracket by a fixing pin.

9. The power trunk mechanism of claim 2,
wherein the vehicle body member is formed to include a wire shape bent in a "U" shape and is connected to each of the hinge link and the vehicle body panel through a hooking structure, and
wherein the vehicle body member includes a stopper provided at an end portion of the vehicle body member, the stopper being formed to include an extending shape to prevent separation of the vehicle body member from the vehicle body panel.

10. The power trunk mechanism of claim 2, wherein the vehicle body member includes a vehicle body link, the vehicle body link being pin-coupled to the hinge link and the vehicle body panel to withstand a load of the trunk lid.

11. The power trunk mechanism of claim 1, further including a spring coupled to the hinge arm and configured to provide rotation force in a rotation direction of the hinge arm, the rotation direction allowing the trunk lid to be opened.

12. The power trunk mechanism of claim 11, wherein the spring has a first end portion connected to a vehicle body and a second end portion connected to one of the hinge arm and the lever unit.

13. The power trunk mechanism of claim 1, further including a gas lifter coupled to the hinge arm and configured to provide rotation force in a rotation direction of the hinge arm, the rotation direction allowing the trunk lid to be opened.

14. The power trunk mechanism of claim 13, wherein the gas lifter has a first end portion connected to a vehicle body and a second end portion connected to one of the hinge arm and the lever unit.

15. The power trunk mechanism of claim 1, wherein the electric drive unit is configured to be rotated relative to the hinge arm in a direction opposite to a rotation direction of the hinge arm.

16. The power trunk mechanism of claim 1,
wherein the lever unit is connected to a front side of the hinge arm, and
wherein the electric drive unit is connected between the hinge arm and the lever unit so that the electric drive unit is constantly located in front of the hinge arm.

17. The power trunk mechanism of claim 1, wherein the electric drive unit comprises:
a motor bracket fixed to the hinge arm;
a motor assembly including a motor configured to provide rotation force to the hinge arm and a rotation shaft rotated in conjunction with the motor and coupled to the motor bracket; and
a connecting link rotatably connected between the motor assembly and the vehicle body member.

18. A vehicle comprising the power trunk mechanism of claim 1.
